(19) United States
(12) Patent Application Publication
(10) Pub. No.: US 2004/0020852 A1
(43) Pub. Date: Feb. 5, 2004

(54) Method and apparatus for calcium profiling in dialysis

(76) Inventor: Lars-Fride Olsson, Lund (SE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,259

(22) PCT Filed: Jun. 15, 2001
(86) PCT No.: PCT/SE01/01360

(51) Int. Cl. C02F 1/44

(52) U.S. Cl. 210/646

(57) ABSTRACT

The invention is directed towards a method for preventing the loss of functionality of a fistula due to the formation of calcium phosphate and other precipitates within the fistula. The method comprises profiling the amount of calcium in the dialysis fluid or blood in relation to the amount of phosphorous in the blood plasma. This invention also comprises a system for profiling calcium during a dialysis procedure.

### FIELD OF THE INVENTION

The present invention relates generally to a dialysis procedure, in particular to a procedure for profiling the concentration of calcium in a fluid over time.

### BACKGROUND OF THE INVENTION

In a dialysis treatment, it is necessary to lead a portion of the patient's blood through an extracorporeal circuit, i.e. outside the body of the patient. For this, access to the patient's bloodstream is needed. The best and most widely used vascular access for chronic hemodialysis treatment is the creation of an arterio-venous fistula (known hereafter as an A-V fistula). An A-V fistula is a joint that is typically surgically created to be a direct connection between a vein and an artery of a patient. The patient's blood flows through the fistula from the artery to the vein. The fistula provides a blood access site to create a blood loop wherein an arterial or inlet line flows from the patient to a dialysis apparatus and a venous or outlet line flows from the dialysis apparatus, back to the patient. The inlet line draws blood to be treated from the patient through a first cannula inserted into the fistula, while the outlet line returns treated blood (i.e., after dialysis), to the patient through a second cannula inserted into the fistula between the first cannula and the vein. Alternatively, the fistula may be a synthetic or animal organ graft connecting any artery to any vein. As used herein, the term “fistula” refers to both of these and any other surgically created or implanted joint between one of the patient's veins and one of the patient's arteries, however created. More generally, the terms “shunt” or “access” also may refer to any similar joint, either in a hemodialysis patient, or in another area.

One side effect of dialysis treatment is that the patient's fistula often gradually loses its ability to efficiently transport blood from artery to vein. Fat and other deposits such as calcium phosphate build up within the fistula over time, and consequently blood flow within the fistula is gradually reduced. Eventually, blood flow may be reduced to such an extent that the fistula must be replaced. Often, multiple replacements may be needed and such repetitious replacements can account for half or more of the long term costs of dialysis treatment.

A well-functioning vascular access is essential for dialysis patients to receive an adequate dose of dialysis. Consequently, sustaining viability of the access remains an important challenge in the management of dialysis patients.

In the United States alone, complications associated with vascular access are a major cause of morbidity in hemodialysis patients, representing over 20% of all hospitalizations. It has been reported that this morbidity accounts for as much as 25% of total end-stage renal disease costs (Butterly, D.; Schwab, S. J.; Reducing the Risk of Hemodialysis Access, Am. J. Kidney Dis. 34:362-363, (1999)), and in 1996 Feldman and co-workers reported the annual costs of access-related morbidity in the United States to amount to $1 billion Feldman, H. I.; Kobrin, S.; Wasserstein, A.; Hemodialysis Vascular Access Morbidity, J. Am. Soc. Nephrol. 7:523-535 (1996)).

One major cause of access dysfunction is the development of vascular stenosis. Vascular stenosis is the abnormal narrowing or constriction of blood vessels. Stenosis causes impairment in the quality of the dialysis procedure and increases the risk of blood clots. Several clinical strategies are commonly used to detect stenosis, such as monitoring venous dialysis pressure, intra-access pressure monitoring and measurement of access recirculation and/or access flow. Correction of the stenotic vessel using percutaneous angioplasty or surgical revision reduces the rate of thrombosis and prolongs survival of the access. However, considering both the suffering of the patients and the associated costs for society it seems equally important to try to identify the underlying pathogenic mechanisms of access stenosis so that preventative strategies can be developed and implemented.

Similarly, access stenosis is the abnormal narrowing or constriction of the access site or fistula. As noted above, access stenosis may also be caused by deposits in the access site or fistula. One such pathogenic mechanism leading to access stenosis may be caused by the breakdown products formed in the blood during cellular metabolism. Such breakdown products are acidic, and consequently cause the blood to become acidic. In people with normal kidney function, the physiological buffer bicarbonate is released from the kidneys in response to a low blood pH, to increase the blood pH to a more neutral level. In patients on dialysis however, this buffering capacity is no longer available from their kidneys, and must be provided by the dialysis procedure. One consequence of the loss of kidney function is that phosphate ions are no longer excreted by the kidneys and thus accumulate in the blood plasma. Low blood acidity may trigger the precipitation of soluble ions such as phosphorous out of the patient's blood. Such precipitation may cause crystals to form in a patient's veins and in the access site or fistula. Calcification of the access site may also occur. Calcification is the hardening of tissue resulting from the deposition of calcium salts and other minerals within the tissue. Calcification may consist of deposition of crystals of calcium phosphate such as brushite, which precipitates out of blood in an acidic environment. Brushite is formed most probably via the reaction of Ca+HPO₄→CaHPO₄. Furthermore, the shape of the brushite crystals may cause activation and damage to both the circulating blood cells as well as to the cells of the vascular wall. In support of this hypothesis, it has been shown that aggregating platelets and fibrin may be found around depositions of brushite in a stenotic vein.

It is believed as noted above that the deposition of calcium phosphate and subsequent deposition of brushite might be involved in the development of stenotic lesions in AV-fistulas of patients in chronic renal failure. Brushite may form in the A-V fistula because the combined concentrations of calcium and phoshate in both the blood and in the dialysis fluid are too high. The deposition of brushite in a fistula may occur because the fistula is a location where blood to be dialysed containing both a high phosphorous ion concentration and a low pH comes in contact with blood which has been dialysed and contains both a lower concentration of ions as well as a higher pH.

In a dialysis procedure both calcium and phosphate ions are transferred from the blood side of the dialyzer to the dialysate side. However, the blood calcium level must be kept above a certain level (about 1.0 mM to prevent life-threatening physiologic failures. To prevent such life-threatening physiologic failures, a hemodialysis procedure must therefore involve the addition of calcium ions to the dialysate to compensate for the blood calcium lost through the dialysis procedure. It is to this difficult balance of calcium regulation in the dialysis fluid and the prevention of brushite formation in an A-V fistula that the present invention is directed.

### SUMMARY OF THE INVENTION

The invention comprises a method for reducing the loss of functionality of a fistula in a patient undergoing dialysis treatment wherein blood is removed from the patient's body at the fistula, circulated through a blood side of a dialyzer and returned to the patient's body at the fistula, and wherein a solution is administered to the patient which comprises administering the solution to the patient at a first calcium concentration for a first period of time; and administering the solution to the patient at a second calcium concentration, greater than the first calcium concentration, for a second period of time following the first period of time. A solution, comprising calcium is commonly known as a calcium solution. “Administrating” or “administered” means administering or delivering to a patient. A method is also provided for varying the concentration of calcium over time.

The invention further comprises a method for reducing the loss of functionality of a fistula in a patient undergoing dialysis treatment wherein blood is removed from the patient's body at the fistula, circulated through a blood side of a dialyzer and returned to the patient's body at the fistula, and wherein calcium is administered to the patient which comprises administering calcium at a first rate, and increasing the rate of calcium administered to the patient over time. A method is also provided for varying the flow rate of the calcium solution over time. The invention also comprises a system for dialysis comprising a first flow circuit for a dialysate solution, a second flow circuit for blood, a filtration unit which includes a semi permeable membrane which divides the filtration unit into a first chamber connected to the first flow circuit and a second chamber connected to the second flow circuit, in which the system is characterized by a supply of calcium concentrate to provide a calcium concentrate fluid flow, and a calcium concentrate fluid flow regulating device for controlling the flow of calcium concentrate fluid. Reference to delivery and administration is found in the “Handbook of Dialysis” 1988, J. T. Daugirdas and T. S. Ing, Little, Brown & Co., Boston/Toronto.

### BRIEF DESCRIPTION OF THE DRAWINGS

FIG. 1 shows an arterio-venous fistula created in the arm of a dialysis patient.

FIG. 2 is a graph of the X-ray spectral patterns of the ions deposited on the interior wall of a stenotic fistula.

FIG. 3 is a graph of the X-ray spectral patterns of the ions deposited on the interior wall of a non-stenotic fistula.

FIG. 4 depicts a representative profile of calcium to phosphorous ions in the dialysate fluid during a dialysis procedure.

FIG. 5 is a schematic representation of a dialysis circuit that may be used to vary the amount of calcium during the dialysis procedure.

FIG. 6 is a schematic representation of another embodiment of a dialysis circuit that may be used to vary the amount of calcium during the dialysis procedure.

### DETAILED DESCRIPTION

As introduced above, a fistula is generally used in a dialysis procedure to access a patient's blood stream. The general term dialysis as used here includes hemodialysis, hemofiltration, hemodiafiltration and therapeutic plasma exchange (TPE), among other similar treatment procedures. In dialysis generally, blood is taken out of a patient's body and exposed to a treatment device to separate substances therefrom and/or to add substances thereto, and is then returned to the body. Although the dialysis procedure used in the present invention will be described by way of example with respect to hemodialysis, it is understood that the invention is not so limited in scope.

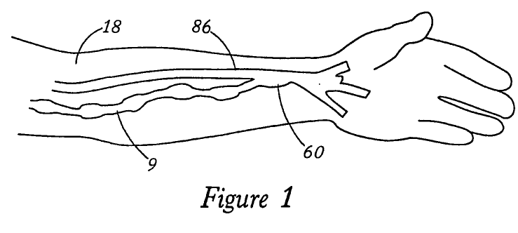

FIG. 1 shows an arterio-venous fistula 60 created, for example, in the arm 18 of a dialysis patient. The surgically created connection 60 between an artery 86 and a vein 9 serves as the location of vascular access to the patient's blood. Blood needing to be dialyzed is withdrawn from the fistula and cleaned blood that has been dialyzed is returned to the patient through the fistula. A fistula is usually located in the arm of a patient, but may be located anywhere a fistula may be placed.

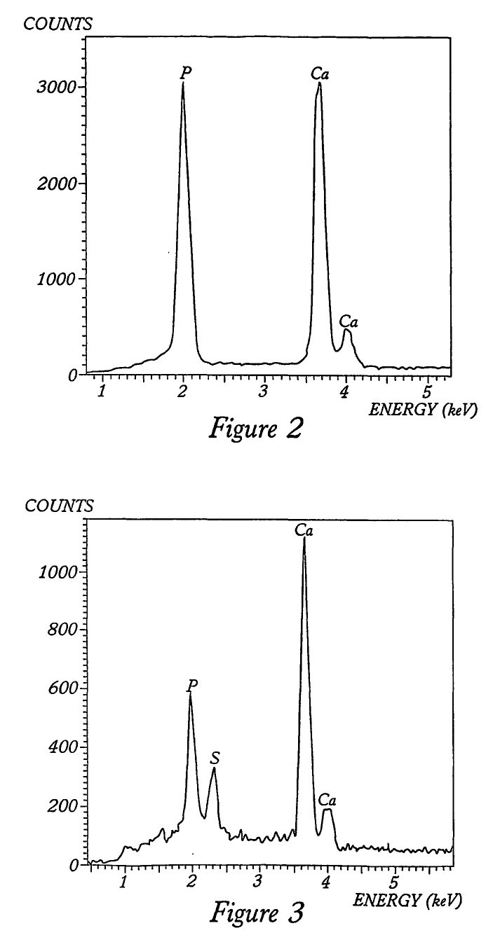

FIG. 2 shows a graph of the X-ray spectral patterns of the ions found deposited on the interior walls of a human stenotic fistula. As shown in the graph, the concentration of phosphorus ions to calcium ions are found in a 1:1 ratio. This corresponds to descriptions of brushite formation in the literature, which describe a 1:1 ratio of phosphorus to calcium. (Elliot, J. C.; Structure and Chemistry of the Apatites and Other Calcium Orthophosphates, Stud. In Inorganic Chem., 18, 23-30 (1994)). In brushite formation, phosphorus exists as monohydrogen phosphate, and deposition of brushite occurs through the direct reaction between the monohydrogen phosphate ion and the calcium ion.

In comparison, FIG. 3 shows a graph of the X-ray spectral patterns of the ions deposited on the interior wall of a non-stenotic fistula. As shown in the graph of FIG. 3, the concentration of phosphorus to calcium ions in a non-stenotic fistula is not found in a 1:1 ratio. This finding corresponds to the lack of brushite crystals found in a non-stenotic fistula.

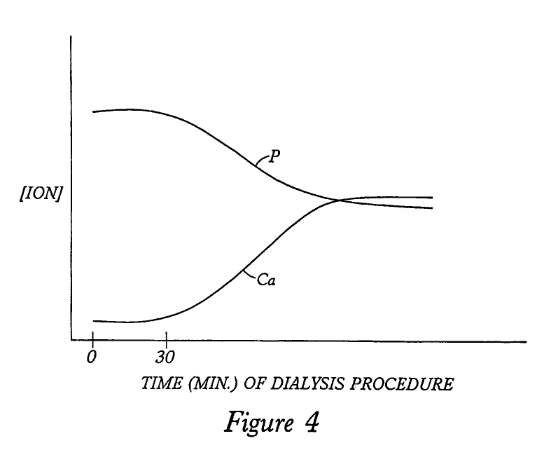

In order to prevent the formation of brushite in a fistula due to the 1:1 concentration of calcium ions to phosphorous ions such as that shown in FIG. 2, the concentration of calcium administered to a patient during the dialysis procedure may be varied over time. As shown in FIG. 4, the amount of calcium present in the dialysate may be varied over the time of the procedure, as well as varied in accordance with any decrease in concentration of phosphorous in the plasma. Alternatively, calcium may be varied over time in a step-wise fashion (not shown). A sensor may also be used which detects the concentration of phosphorous in the blood plasma of the individual patient and adjusts the calcium concentration accordingly. In another alternative, a calcium profile could be set up which presumes that the phosphorous concentration in blood plasma decreases at a standard rate regardless of the patient, and so utilizes a standard profile.

Calcium profiling is premised on the fact that the blood level of monohydrogen phosphate decreases during the dialysis session. Therefore, at some time period after the start of the dialysis procedure, when monohydrogen phosphate level is low enough that it is unlikely brushite formation will occur, the addition of calcium to the blood or to the dialysate fluid may be initiated.

To further clarify, the calcium ion concentration in the fistula depends to some extent on the concentration of calcium contained in the dialysate fluid, whereas the phosphorous ion concentration comes solely from plasma phosphate. If the concentration of phosphate in blood plasma may be decreased by dialysate having a low concentration of calcium, then when the dialysis session has been going on for some period of time, for example between 15 to 30 minutes as shown in the exemplary profile of FIG. 4, the concentration of plasma calcium may then be increased by addition of calcium to the dialysate fluid. Such calcium profiling may help decrease the likelihood of brushite formation. This concept assumes that the concentration of phosphorous ions in the blood is highest at the beginning of a dialysis procedure and subsequently decreases over time as the procedure continues. Furthermore, by keeping the pH of the dialysate high, calcium and phosphate ions will more easily remain in solution, and possible brushite formation in a fistula may be potentially avoided.

FIG. 4 shows one proposed profile of the ratio of calcium ions in the dialysate to phosphorus ions in the blood of a dialysis patient during a dialysis procedure in accordance with the instant invention. The concentration of calcium ions in the dialysate is graphed against the concentration of phosphorus ions in blood plasma over time. As shown in FIG. 4, at the beginning of the dialysis procedure, at a first period of time, the concentration of phosphorus in the blood plasma is high. Accordingly, the concentration of calcium administered to the patient in either the dialysate fluid or directly into the patient's blood is kept low. As the dialysis procedure progresses, at a second period of time, the amount of phosphorous in the blood decreases due to filtration by the dialyzer. Accordingly, the concentration of calcium in the dialysate solution is increased. By varying the concentration of calcium in response to the concentration of phosphorus in the blood in accordance with the instant invention, the formation of brushite crystals in the fistula may be avoided, thereby decreasing the probability of calcification of the fistula and subsequent stenosis due to brushite formation.

In another embodiment, (not shown) the amount of calcium administered to the patient either in the dialysis fluid or directly into the patient's blood may be increased by increasing the flow rate of the solution containing calcium over time.

The profile shown in FIG. 4 is merely exemplary, and is not meant to be limiting. It is understood that other profiles could be developed by those skilled in the art utilizing the principles described herein. The use of different profiles will be described in greater detail below.

Here below follows descriptions of embodiments which are currently believed to be solutions to avoid the formation of brushite in fistulas of dialysis patients.

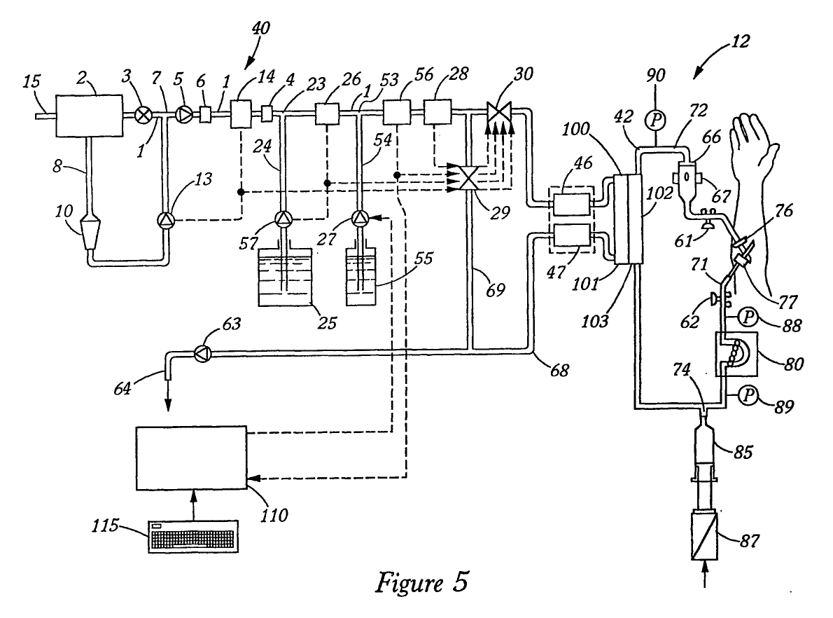

Referring to the figures, in which like reference numerals refer to like portions thereof, FIG. 5 shows by way of a schematic diagram one embodiment of an extracorporeal blood treatment system capable of performing a calcium profiling procedure according to the present invention.

A first flow circuit 40 for a dialysis procedure comprises a main or primary conduit 1 which originates from a suitable source of water, such as a liquid reservoir or heating vessel 2. The liquid reservoir 2 may include an inlet 15 for introduction of pure water thereinto, for example, from a reverse osmosis unit (not shown). The main conduit 1 may include a throttling mechanism 3, a pressure gauge 4, a pump 5 and a deaerating device 6 which may be provided with an air outlet (not shown). The main conduit may also contain one or more conductivity meters 14 and 26 respectively.

Water may enter the first flow circuit 40 from the liquid reservoir 2 via the main or primary conduit 1 or alternatively may enter the circuit through a first concentrate circuit 8. Concentrate circuit 8 may contain a powder concentrate column 10, which may contain sodium bicarbonate powder. The first concentrate circuit 8 communicates with the main conduit 1 at a mixing point 7. A conductivity meter 14 or other measuring device may also be provided in the main conduit 1. The conductivity meter 14 or other measuring device is adapted to control a flow regulating device or pump 13 provided in the concentrate conduit 8 downstream of the powder concentrate column 10. If, as described below, the flow regulating device 13 is a throttle, the main line throttle device 3 should be located upstream of the mixing point 7 as shown. According to another embodiment, the flow regulating device may be a metering dosage pump, a variable displacement pump, or a proportional valve (not shown).

As mentioned, the flow regulating device 13 may be a simple adjustable throttling device. This is advantageous in that a single pump 5 may be employed for withdrawing water from the reservoir 2 for both the main dialysate flow through line 1 and for production of the concentrate fluid in fluid conduit 8. If the throttling device 3 is located in the main line 1 between the source of water 2 and mixing point 7, and if the deaerating device 6 is located in the main duct downstream of pump 5, the same pump 5 may also be used to deaerate both the main line 1 and the prepared dialysate fluid. For the preparation of dialysate fluids, the pump 5 is preferably operative to handle flow rates up to at least 500 ml/min, and more preferably, up to approximately 1,000 ml/min in the main line 1. The flow regulating means 13 on the other hand should be preferably operative to handle flow rates up to approximately 40 ml/min or at least 30 ml/min at flow rates of approximately 1,000 ml/min in the main line 1.

A second mixing point 23 is provided downstream of conductivity meter 14. At mixing point 23, a second concentrate fluid preferably containing sodium chloride, magnesium chloride, potassium chloride, small amounts of acetic acid and glucose may be introduced into the main line 1 via a second concentrate conduit or duct 24. This second concentrate may be in a solid or a liquid form, however, in the preferred embodiment, the concentrate is in a liquid form. The second concentrate 25 corresponds substantially to the conventional “A” concentrate known in the art. In a preferred embodiment, the second concentrate does not contain calcium. The flow of second concentrate fluid through the second concentrate duct 24 may be regulated with the aid of a conductivity meter 26 or other measuring device which may be located downstream of mixing point 23 in the main conduit 1. Conductivity meter 26 controls a flow regulating device 27, located in the second concentrate duct 24.

In the embodiment shown in FIG. 5, a third mixing point 53 may be provided downstream of conductivity meter 26. At mixing point 53, a fluid containing concentrated calcium may be introduced into the primary conduit 1 via a third concentrate conduit or duct 54. Duct 54 communicates with a source of concentrate 55, which in this instance, is a container containing calcium concentrate. The concentrated calcium may be in a solid or a liquid form such as a calcium solution without departing from the spirit and scope of the invention. According to one embodiment, the calcium concentration in a dialysate solution may be a solution containing calcium chloride. The calcium solution may have a variable amount of calcium of between 1 mM to 1.75 mM (Kracler, M., Scharfetter, H., Wimsberger, G. H., Clinical Nephrology, 2000, 54:35-44, and Argiles i Ciscart, A, Nephrol Dial. Transplant. 1995, 10:451-454).

The amount of calcium concentrate released through the third concentrate duct 54 may be regulated with the aid of a conductivity meter 56 or other measuring device located in the main conduit 1. Conductivity meter 56 may control a flow regulating device 57 located in concentrate duct 54. Flow regulating device 57 may be a variable output pump or may be a proportional valve.

Thus, as shown in FIG. 5, it will be appreciated that if three concentrates 10, 25 and 55 respectively are to be conducted to the main duct 1 at three separate mixing points 7, 23 and 53 it is important that conductivity meters 14, 26 and 56 or other similar measuring devices for accurate monitoring of the composition of the prepared solution be used. In this fashion, the dialysate solution composition may be accurately monitored both upstream as well as downstream of the second and third mixing points 23 and 53.

For ultimate monitoring of the pH of the prepared dialysate solution, an optional pH meter 28 maybe located in the main conduit 1 downstream of the third mixing point 53, but upstream of a bypass valve 29 and a main valve 30 through which the system may be connected to a dialyzer 100. If the measurements obtained in the main conduit 1 from any one or all of conductivity meters 14, 26 or 56 and/or pH meter 28 are not in accord with the desired values, the main valve 30 may be closed and bypass valve 29 opened. For this purpose, conductivity meters 14, 26 and 56 and pH meter 28 are all shown as providing input for controlling valves 29 and 30. Although the various meters for measuring the properties of the fluid being conducted through main conduit 1 preferably control the valves 29 and 30, it will also be appreciated that it is possible instead to control one or more of the pumps 5, 13, 27 and 57 to stop or otherwise alter the flow of fluid into and through the various conduits.

As shown in FIG. 5, control unit 110 is preferably connected to the variable output pump 57 for controlling the concentration of calcium in the dialysate as a function of time. For this purpose the control unit 110 receives a signal from conductivity meter 56 and sends a control signal to pump 57. Thus the variable output pump 57 is controlled by a closed loop feedback system. A number of profiles of a desired calcium concentration versus time may be stored in the control unit 110. One example of such a profile is shown in FIG. 4 described above. Because patients react very differently to low calcium concentrations, one embodiment may comprise the personal calcium concentration profiles of individual patients stored in control unit 110. Another embodiment may be to store specific profiles for certain patient types or patient groups. The control unit 110 may also comprise a user interface 115 for manual or automatic adjustment and selection of a specific calcium profile. According to another embodiment the control unit 110 communicates with other control elements (not shown) of the dialysis system for exchange of data in order to perform an automatic selection and adjustment of a calcium profile.

In the embodiment of FIG. 5, downstream of valve 30 a flow meter 46 may be located in the primary conduit 1. The primary conduit 1 extends to the filtration or processing unit 100. In dialysis, filtration unit 100 may be a dialyzer, which may also be referred to as a filter. The dialyzer or filtration unit 100 may be a hemodialfiltration unit, a hemofiltration unit, an ultrafiltration unit, or other types of filtration devices known in the art. Filtration unit 100 is shown schematically divided into a primary chamber 101 separated from a secondary chamber 102 by a semi-permeable membrane 103 (not shown in detail). In this extracorporeal system, primary chamber 101 of the dialyzer 100 accepts fluid from the dialysate or first flow circuit 40 and secondary chamber 102 accepts blood from the blood or second flow circuit 12. A conduit 68 extends from flow meter 47 to pump 63, which transports the dialysate to an outlet 64. Another conduit 69 connects the outlet of valve 29 to conduit 68.

As introduced above, the system generally includes a second flow circuit 12, which is an extracorporeal blood flow circuit, having first and second conduits 71 and 72 which are both connected to the vascular system of a patient (see element 60 of FIG. 1). Blood access and return devices 76 and 77 respectively, remove and return blood to the patient. The access and return devices 76 and 77 may be cannulas, catheters, winged needles or the like as understood in the art. Conduits 71 and 72 are also connected to the filtration or processing unit 100. A peristaltic pump 80 is disposed in operative association with the first conduit 71. In FIG. 5, the extracorporeal blood flow circuit 12 preferably includes a conventional anticoagulant pump 85 for mixing anticoagulant such as heparin into the flow of blood at a mixing point 74. The anticoagulant pump 85 may be a syringe filled with heparin concentrate and may contain an actuator 87 that may be controlled from a control unit (not shown). As understood in the art, an air bubble trapping drip chamber 66 for deaerating the blood is shown in the second conduit 72. A bubble detector 67 is often included on or adjacent to bubble trap 66. Numerous other component devices may be used in the extracorporeal blood flow circuit 12 without departing from the spirit and scope of the invention. Pressure sensors 88, 89 and 90 may be included in the extracorporeal circuit as well as tubing clamps 61 and 62.

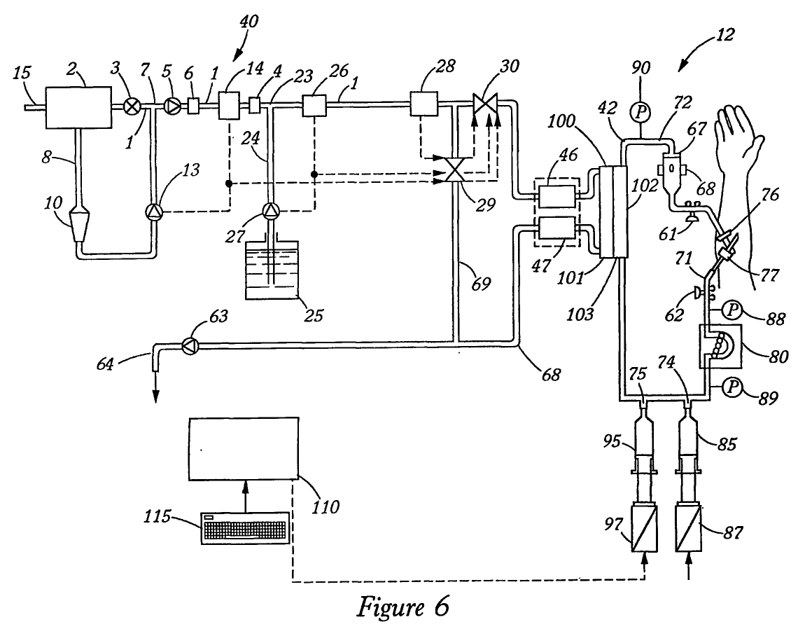

As shown in FIG. 6, and as previously described above with reference to the embodiment described in FIG. 5, the first flow circuit for a dialysis solution comprises a main or primary conduit 1 in which various concentrates may be mixed. Except as described in further detail below, the embodiment of FIG. 6 is similar to the embodiment described in FIG. 5, wherein like numbers represent corresponding like elements. Repeat description of these elements will not be further repeated here. In FIG. 6, the calcium concentrate sub-system (see mixing point 53, tubing 54, container 55 and pump 57 of FIG. 5) is not included for connection into primary line 1.

In FIG. 6 a calcium pump 95 similar in construction to conventional anticoagulant pump 85 may be used to deliver calcium to the blood flow side of extracorporeal circuit 12. The pump 95 delivers calcium to the circuit 12 at a calcium mixing point 75 located in conduit 71 downstream of the anticoagulant mixing point 74. Some calcium added to blood circuit 12 from pump 95 may migrate across membrane 103 of the filter 100 and may enter the dialysis circuit 40. Once calcium enters the dialysis circuit 40, some calcium may be lost via the dialysate outlet 64. Because of this, calcium must be added to the system in a higher concentration or amount than necessary for the patient, with the understanding that some amount of calcium will be lost to the dialysis circuit side 40.

An alternative embodiment (not shown) to prevent the loss of calcium across the membrane 103 is to connect a calcium pump similar to pump 95 shown in FIG. 6 to the blood circuit side 12 at location 42 of tubing segment 72. Such a connection may prevent calcium from entering the dialysis circuit. The calcium would flow directly into the patient via blood return device 76.

The calcium pump 95 may be a syringe containing calcium concentrate infusion fluid and may also be connected to an actuator mechanism 97, which may in turn be connected to control unit 110.

According to another embodiment (not shown) the calcium pump for delivering the calcium concentrate may be a peristaltic pump. For accurate dosing of a patient, the calcium concentrate may also be supplied from a bag that is suspended from a balance. A signal from the balance may be used by the control unit 110 to drive the pump. The addition of calcium into the extracorporeal circuit may also be added at other locations within the circuit without departing from the spirit and scope of the present invention. Calcium addition can be by other well known methods and means including but not limited to a stepper motor.

It has been further hypothesized that the pH of blood may play a role in the formation of brushite crystals in a fistula. At a pH less than 7.3, calcium phosphate may precipitate out of the blood in such a way as to form brushite crystals. At a blood pH greater than 7.5 however, calcium phosphate may precipitate out of the blood as hydroxyapatite crystals, which do not contribute to the formation of stenosis in a fistula. Another way to avoid brushite formation is to keep the pH of plasma sufficiently high in some way, either with or without the calcium profiling described above. This might be achieved by acetate free bio-filtration (not shown) or by infusing bicarbonate directly into the blood stream (not shown).

It should be understood that various changes and modifications to the described embodiments will be apparent to those skilled in the art. These examples are not meant to be limiting, but rather are exemplary of the modifications that can be made without departing from the spirit and scope of the present invention and without diminishing its attendant advantages.

1. A method for reducing the loss of functionality of a fistula in a patient undergoing dialysis treatment wherein blood is removed from the patient's body at the fistula, circulated through a blood side of a dialyzer and returned to the patient's body at the fistula, and wherein a calcium solution is administered to the patient comprising;
administering the calcium solution to the patient at a first calcium concentration; and
increasing the calcium concentration of the calcium solution administered to the patient over time.

2. The method of claim 1 wherein the step of administering the calcium solution comprises administering calcium to the blood of a patient.

3. The method of claim 1 wherein the first calcium concentration is selected to correspond to a first period of time during which a concentration of plasma phosphate in the patient's blood is high.

4. The method of claim 1 wherein the increased calcium concentration is selected to correspond to a period of time during which a concentration of plasma phosphate in the patient's blood is relatively lower than during the first period of time.

5. The method of claim 1 further comprising maintaining the plasma pH of the patient's blood at a pH of around 7.3 throughout the first and second periods of time.

6. The method of claim 1 wherein the solution is a dialysate and the dialysate is administered to the patient by circulating through the dialysate side of the dialyzer.

7. The method of claim 1 wherein the solution can be an infusion fluid and the infusion fluid is administered to the blood removed from or returned to the fistula.

8. A method for reducing the loss of functionality in a fistula according to claim 1, wherein the method comprises reducing the formation of brushite in a fistula.

9. A method for reducing the loss of functionality in a fistula according to claim 1, wherein the method comprises preventing the calcification of a fistula.

10. A method for profiling the calcium concentration in a dialysate used to treat a patient undergoing dialysis treatment wherein blood is removed from the patient's body at the fistula, circulated through a blood side of a dialyzer and returned to the patient's body at the fistula and wherein a calcium solution is administered to the patient comprising;
administering the calcium solution to a patient at a first calcium concentration; and
increasing the calcium concentration over time.

11. The method of claim 10 wherein the step of administering the calcium solution comprises administering calcium to the blood of a patient.

12. The method of claim 10 wherein the first calcium concentration is selected to correspond to a first period of time during which a concentration of plasma phosphate in the patient's blood is relatively high.

13. The method of claim 10 wherein the increased calcium concentration is selected to correspond to a period of time during which a concentration of plasma phosphate in the patient's blood is relatively lower than during the first period of time.

14. The method of claim 10 further comprising maintaining the plasma pH of the patient's blood at a pH of around 7.3 throughout the first and second periods of time.

15. The method of claim 10 wherein the solution is a dialysate and the dialysate is administered to the patient by circulating through the dialysate side of the dialyzer.

16. The method of claim 10 wherein the solution can be an infusion liquid and the infusion liquid is administered by infusion into the blood removed from or returned to the fistula.

17. A system for hemodialysis, hemodiafiltration or hemofiltration comprising:
a first flow circuit for a dialysate solution,
a second flow circuit for blood,
a filtration unit which includes a semi-permeable membrane which divides the filtration unit into a first chamber connected to the first flow circuit and a second chamber connected to the second flow circuit,
a supply of calcium concentrate to provide a calcium concentrate fluid flow, and
a calcium concentrate fluid flow regulating device for controlling the flow of calcium concentrate fluid.

18. The system according to claim 17 wherein the fluid flow regulating device varies the amount of calcium concentrate fluid over time.

19. The system according to claim 17 wherein the fluid flow regulating device varies the amount of calcium concentrate fluid flow in a step-wise manner.

20. The system according to claim 17, wherein the flow of calcium concentrate fluid is directed into the first flow circuit at a mixing point for mixing with the dialysate fluid.

21. The system according to claim 17, comprising a meter located in the first flow circuit downstream of the mixing point for measuring the composition of the prepared solution obtained by mixing the calcium concentrate with the dialysate solution.

22. The system according to claim 17, wherein the flow regulating device is responsive to the meter.

23. The system according to claim 17, comprising a control unit connected to the flow regulating device, the control unit being capable of producing a profile for a desired calcium concentration in the dialysate fluid.

24. The system according to claim 23, wherein the control unit stores profiles for specific patients or specific type of patients.

25. The system according to claim 23, wherein the control unit comprises a selection means for automatic or manual adjustment of a profile for a desired calcium concentration.

26. The fluid flow regulating device of claim 17, wherein the flow regulation device comprises a pump for regulating the flow of calcium concentrate fluid.

27. The fluid flow regulating device of claim 17, wherein the flow regulation device comprises a variable throttling means for regulating the flow of calcium concentrate fluid.

28. The system according to claim 17 further comprising a container containing calcium concentrate fluid.

29. The system according to claim 20 wherein the dialysate has a calcium concentration of between 1 mM to 1.75 mM.

30. The system according to claim 21 wherein the meter comprises a conductivity meter.

31. The system according to claim 17 further comprising at least one additional source of concentrate and a means for introducing the additional concentrate into the first flow circuit to be mixed with the dialysis solution.

32. The system according to claim 31, further comprising alternative mixing points in the first flow circuit for mixing the additional concentrate with the dialysis solution.

33. The system according to claim 31 wherein the additional concentrate contains a substance selected from the group consisting of an acid, potassium, magnesium, or glucose.

34. A system according to claim 31 wherein the additional concentrate contains bicarbonate.

35. The system according to claim 17 wherein the first flow circuit includes a primary flow regulating means for regulating the flow of fluid through the first flow circuit, the primary flow regulating means being operative to provide a flow rate of at least 500 ml/min through the first flow circuit downstream of the mixing point.

36. The system according to claim 17, wherein the flow of calcium concentrate fluid is directed into the second flow circuit at a mixing point for mixing with blood.

37. The system according to claim 17, wherein the calcium concentrate supply and flow regulating device comprise a syringe containing calcium concentrate.

38. The system according to claim 37, wherein the calcium concentrate supply and flow regulating device comprise an actuator acting on the plunger of the syringe.

39. The system according to claim 38, wherein the actuator comprises a stepper motor.

40. A method for reducing the loss of functionality of a fistula in a patient undergoing dialysis treatment wherein blood is removed from the patient's body at the fistula, circulated through a blood side of a dialyzer and returned to the patient's body at the fistula, and wherein calcium is administered to the patient comprising;
administrering calcium at a first rate; and
increasing the rate of calcium administered to the patient over time.

41. The method according to claim 40 wherein the calcium is administered to the patient by a calcium solution; and wherein the step of increasing the rate of calcium delivered to the patient comprises increasing the flow rate of said calcium solution.

42. The method according to claim 40 wherein the calcium is administered to the patient by a calcium solution; and wherein the step of increasing the rate of calcium delivered to the patient comprises increasing the calcium concentration of said calcium solution.
